(19) United States
(12) Patent Application Publication
(10) Pub. No.: US 2005/0017922 A1
(43) Pub. Date: Jan. 27, 2005

(54) Method for controlling an organic light-emitting diode display, and display applying this method

(75) Inventors: Bruno Devos, Zulte (BE); Herbert Van Hille, Cambridge, MA (US); Robbie Thielemans, Nazareth (BE)

Correspondence Address: WOOD, HERRON & EVANS, LLP, 2700 CAREW TOWER, 441 VINE STREET, CINCINNATI, OH, 45202, US

(73) Assignee: BARCO, naamloze vennottschap

(21) Appl. No.: 10/656,606

(22) Filed: Sep. 5, 2003

(30) Foreign Application Priority Data
Jul. 22, 2003 (EP) 03077280.0

(51) Int. Cl. G09G 5/00

(52) U.S. Cl. 345/6

(57) ABSTRACT

Method for controlling an organic light-emitting diode display, said display (400) comprising a plurality of organic light-emitting diodes (OLEDs) (212) having an anode and a cathode, said organic light emitting diodes (212) being arranged in a common anode configuration, whereby said diodes (212) co-operate with constant current sources (214) and are fed by means of a power supply, characterized in that a power supply compensation is applied, in which a voltage drop is measured across the current sources (214) and wherein the measured voltage drop is used as an indicator for the light output of the organic light emitting diodes (212) and wherein said power supply is adjusted in function of said measured voltage drop.

### FIELD OF THE INVENTION

The present invention relates to a method for controlling an organic light-emitting diode (OLED) display, as well as to a display applying this method. In particular, this invention relates to power supply compensation in an OLED display for overcoming light output variations due to OLED aging.

### BACKGROUND OF THE INVENTION

OLED technology incorporates organic luminescent materials that, when sandwiched between electrodes and subjected to a DC electric current, produce intense light of a variety of colors. These OLED structures can be combined into the picture elements, or pixels, that comprise a display. OLEDs are also useful in a variety of applications as discrete light-emitting devices or as the active element of light-emitting arrays or displays, such as flat-panel displays in watches, telephones, laptop computers, pagers, cellular phones, calculators, and the like. To date, the use of light-emitting arrays or displays has been largely limited to small-screen applications such as those mentioned above.

The market is now, however, demanding larger displays with the flexibility to customize display sizes. For example, advertisers use standard sizes for marketing materials. However, those sizes differ based on location. Therefore, a standard display size for the United Kingdom differs from that of Canada or Australia. Additionally, advertisers at trade shows need bright, eye-catching, flexible systems that are easily portable and easy to assemble/disassemble. Still another rising market for customizable large display systems is the control room industry, in which maximum display quantity, quality, and viewing angles are critical. Demands for large-screen display applications possessing higher quality and higher light output have led the industry to turn to alternative display technologies that replace older LED and liquid crystal displays (LCDs). For example, LCDs fail to provide the bright, high light output, larger viewing angles, and high resolution and speed requirements that the large-screen display market demands. By contrast, OLED technology promises bright, vivid colors in high resolution and at wider viewing angles. However, the use of OLED technology in large-screen display applications, such as outdoor or indoor stadium displays, large marketing advertisement displays, and mass-public informational displays, is only beginning to emerge.

Several technical challenges exist relating to the use of OLED technology in a large-screen application. Presently, in the case of a display consisting of a single OLED display panel, the OLEDs do not age uniformly. Thus, when the light output and/or uniformity are no longer suitable, the entire display is replaced. However, in the case of a display consisting of a set of tiled OLED display panels, there is the possibility that one OLED display ages at a much faster rate than another. Age differences occur, for example, due to the varying ON time (i.e., the amount of time that the OLED has been active) of the individual OLEDs and due to temperature variations within a given OLED display area, or due to the replacement of a defect module by a new module. This results in one part of the screen having a lower light output or a color shift as compared with the rest of the tiled OLED display.

Typically, when a tiled OLED display is manufactured, it is calibrated for a uniform image; however, due to aging of the separate modules over the lifetime of the tiled OLED display, the light emission changes from one module to the next. Thus, over time the image is no longer uniform. Consequently, in a large-screen tiled OLED display application, a technical challenge exists to compensate for the difference in light output from one OLED display to another in order to achieve uniform display output.

U.S. Pat. No. 6,448,716 describes a solid-state light apparatus ideally suited for use in traffic control signals having a self-diagnostic/predictive failure analysis (SD/PFA) function facilitating a real-time status of the signal as well as a prediction of failure years in advance of the actual failure. Unlike incandescent signals, all LED-based signals degrade over time until they are no longer within Department of Transportation (DOT) light output specifications. Current state of the art solid-state signals must be periodically monitored to see whether the light output is within specification. A signal system with SD/PFA coupled with a modem or RF link provides real-time data on the status of the signal. The system also provides data that allow the determination via an algorithm of when the signal will fall below light output specifications in the future. While said patent describes an apparatus and method of monitoring and compensating the light output of an LED device, the apparatus and method of this patent is not particularly well suited for a large-screen tiled OLED display application and is therefore not suitable for use in achieving uniform display output in a large-screen tiled OLED display.

### SUMMARY OF THE INVENTION

It is therefore an object of the invention to provide a method of adjusting the power supply voltage of an OLED display over time to compensate for light output changes due to aging.

It is therefore another object of the invention to optimize the power dissipation of an OLED display over the full lifetime of the display.

It is therefore yet another object of the invention to minimize the temperature of an OLED display over the full lifetime of the display, thereby extending the OLED display lifetime.

To this end, the invention provides a method for controlling an organic light-emitting diode display, said display comprising a plurality of organic light-emitting diodes (OLEDs) having an anode and a cathode, said organic light emitting diodes being arranged in a common anode configuration, whereby said diodes co-operate with constant current sources and are fed by means of a power supply, characterized in that a power supply compensation is applied, in which a voltage drop is measured across the current sources and wherein the measured voltage drop is used as an indicator for the light output of the organic light emitting diodes and wherein said power supply is adjusted in function of said measured voltage drop.

In particular the measured voltage drop across a set of constant current sources within the drive circuit of a common-anode, passive-matrix, large-screen OLED array is used as an indicator of OLED light output and a positive power supply associated with the large-screen OLED array is adjusted to ensure that the voltage at the cathode of each OLED is greater than or equal to a predetermined threshold voltage. Accordingly, voltage compensation is preferably performed periodically to compensate for any decrease in light emission due to the aging of the OLEDs. Furthermore, the voltage compensation method of the present invention preferably ensures that a predetermined maximum power dissipation is not exceeded.

Other details of the invention and preferred features will become clear from the following detailed description and from the appended claims.

The invention also relates to an organic light-emitting diode display which uses the abovesaid method, and to this end is provided of electronics to realize this method.

### BRIEF DESCRIPTION OF THE DRAWINGS

With the intention of better showing the characteristics of the invention, hereafter, as example without any limitative character, some preferred forms of embodiment are described, with reference to the accompanying drawings, wherein:

FIG. 1 illustrates an example tile, which is representative of a portion of a modular and scalable OLED display system;

FIG. 2 illustrates a schematic diagram of an OLED circuit, which is representative of a portion of a typical common-anode, passive-matrix, large-screen OLED array;

FIG. 3 illustrates an example tile, which is representative of a portion of a modular and scalable OLED display system in another embodiment of the invention;

FIG. 4 illustrates an example OLED display, which is representative of a modular and scalable OLED display system;

FIG. 5 is a flow diagram of a method of providing voltage compensation within an OLED display device in accordance with the invention.

### DETAILED DESCRIPTION OF PREFERRED EMBODIMENTS

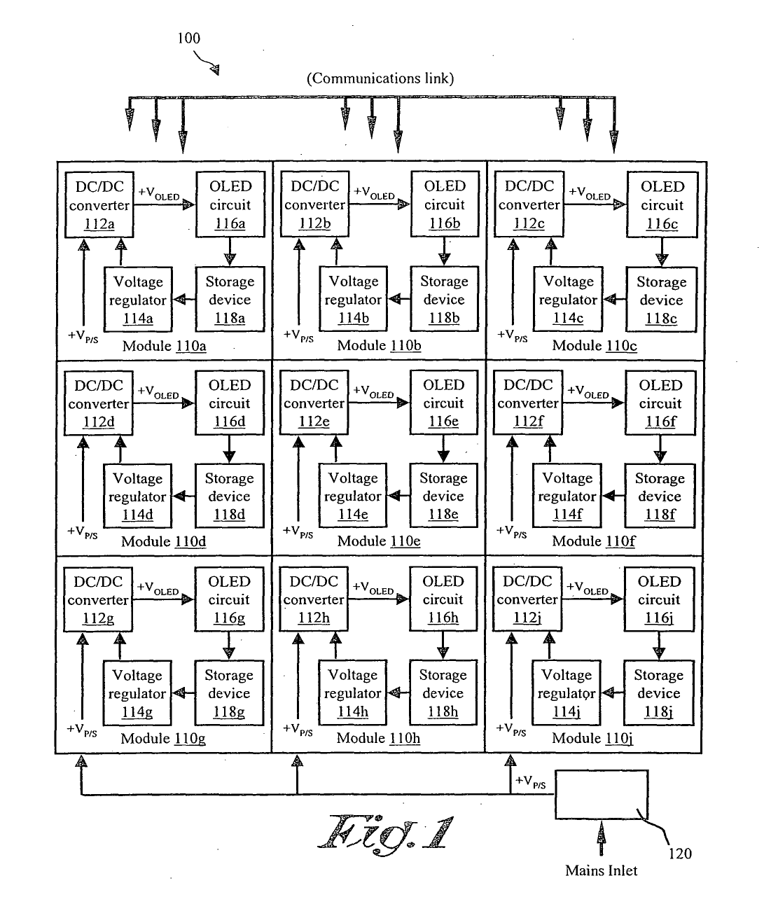

FIG. 1 illustrates an example tile 100, which is representative of a portion of a modular and scalable OLED display system. Tile 100 is formed of an array of modules 110, for example, but not limited to a module 110a , a module 110b , a module 110c , a module 110d , a module 110e, a module 110f, a module 110g, a module 110h, and a module 110j, arranged in a 3×3 array as shown in FIG. 1. Each module 110 further includes a DC-to-DC (DC/DC) converter 112, a voltage regulator 114, an OLED circuit 116, and a storage device 118. More specifically, modules 110a through 110j include DC/DC converters 112a through 112j, respectively; voltage regulators 114a through 114j, respectively; OLED circuits 116a through 116j, respectively; and storage devices 118a through 118j, respectively. DC/DC converter 112 is a conventional DC-to-DC converter device built with discrete components (i.e., controller, switch, inductors, capacitors, etc.), which accepts a DC input and generates a DC output of a different voltage. DC/DC converter 112 receives a DC voltage in and typically performs a voltage down-conversion, which maintains its output voltage at a constant level regardless of input voltage variations as long as the input voltage is within a specified tolerance. The output voltage is programmable, to provide a DC voltage output of between 5 and 20 volts at up to 1 amps. Voltage regulator 114 is a conventional voltage regulator device, such as a digital-to-analog converter (DAC) that regulates the voltage feedback of DC/DC converter 112. More specifically, an output of DC/DC converter 112 feeds OLED circuit 116. The output voltage of voltage regulator 114 is programmable. The programmability of DC/DC converter 112 and voltage regulator 114 is accomplished by any standard local or remote processor device (not shown) via a standard parallel or serial communications link feeding each module 110 of tile 100, as shown in FIG. 1.

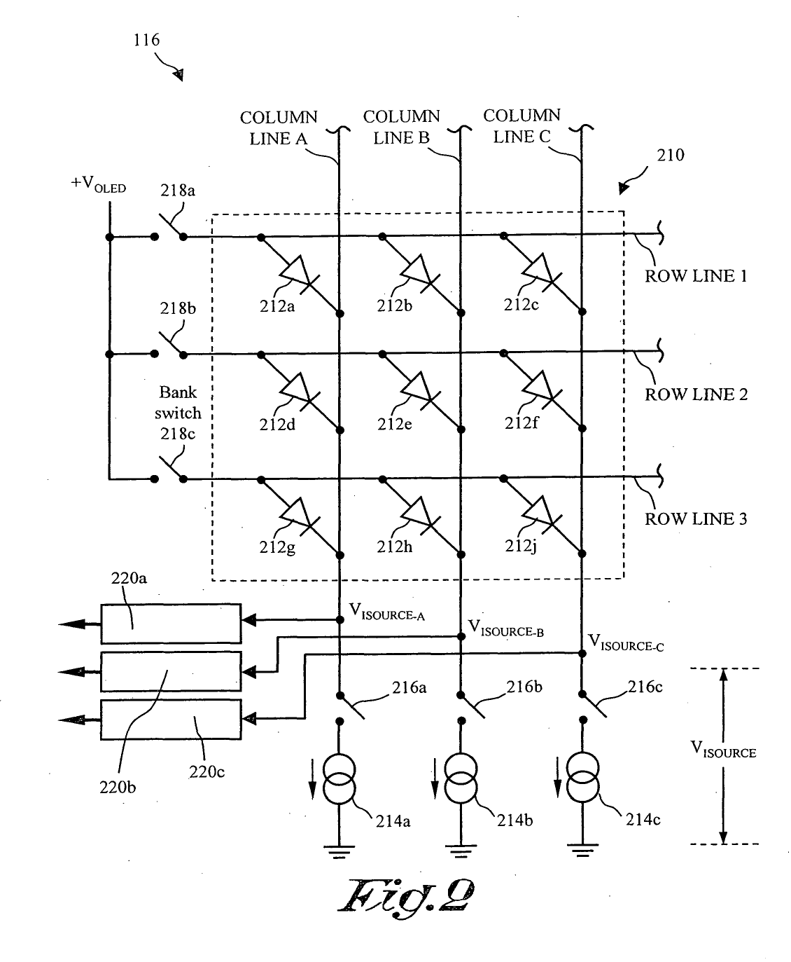

OLED circuit 116 is formed of an OLED array and associated drive circuitry suitable for use in a large-screen display device application. OLED circuit 116 is described in detail in FIG. 2. Finally, storage device 118 is a standard digital storage device, such as a register or RAM, which serves as a local storage device upon module 110 for storing module-specific data.

With reference to module 110a of tile 100, which is representative of all modules 110, a positive voltage +V_{P/S} is electrically connected to a first input of DC/DC converter 112a, an output of DC/DC converter 112a is electrically connected to an input of OLED circuit 116a, an output of OLED circuit 116a is electrically connected to an input of the storage device 118a, an output of storage device 118a is electrically connected to an input of voltage regulator 114a, an output voltage regulator 114a is electrically connected to a second input of DC/DC converter 112a. Furthermore, with reference to modules 110a through 110j, +V_{P/S} is supplied by a power supply 120, which provides +V_{P/S} as a common input voltage to DC/DC converters 112a through 112j. +V_{P/S} typically ranges between 20 and 24 volts. Power supply 120 is a conventional switching power supply, such as a standard AC/DC power supply with Power Factor Correction, having a regulated output voltage of between 20 and 24 volts at up to 7 amps.

FIG. 2 illustrates a schematic diagram of OLED circuit 116, which is representative of a portion of a typical common-anode, passive-matrix, large-screen OLED array. OLED circuit 116 includes an OLED array 210 formed of a plurality of OLEDs 212 (each having an anode and cathode, as is well known) arranged in a matrix of rows and columns. For example, OLED array 210 is formed of OLEDs 212a, 212b, 212c, 212d, 212e, 212f, 212g, 212h, and 212j arranged in a 3×3 array, where the anodes of OLEDs 212a, 212b, and 212c are electrically connected to a row line 1, the anodes of OLEDs 212d, 212e, and 212f are electrically connected to a row line 2, and the anodes of OLEDs 212g, 212h, and 212j are electrically connected to a row line 3. Furthermore, the cathodes of OLEDs 212a, 212d, and 212g are electrically connected to a column line A, the cathodes of OLEDs 212b, 21e, and 212h are electrically connected to a column line B, and the cathodes of OLEDs 212c, 212f, and 212j are electrically connected to a column line C.

A pixel, by definition, is a single point or unit of programmable color in a graphic image. However, a pixel may include an arrangement of sub-pixels, for example, red, green, and blue sub-pixels. Each OLED 212 represents a sub-pixel (typically red, green, or blue; however, any color variants are acceptable) and emits light when forward-biased in conjunction with an adequate current supply, as is well known.

Column lines A, B, and C are driven by separate constant current sources, i.e., they may be connected to a plurality of current sources (I_{SOURCES}) 214 via a plurality of switches 216. More specifically, column line A is electrically connected to I_{SOURCE} 214a via switch 216a, column line B is electrically connected to I_{SOURCE} 214b via switch 216b, and column line C is electrically connected to I_{SOURCE} 214c via switch 216c. I_{SOURCES} 214 are conventional current sources capable of supplying a constant current typically in the range of 5 to 90 mA. Switches 216 are formed of conventional active switch devices, such as MOSFET switches or transistors having suitable voltage and current ratings.

A positive voltage (+V_{OLED}) from voltage regulator 114, typically ranging between 3 volts (i.e., threshold voltage 1.5V to 2V+voltage over current source, usually 0.7 V) and 15-20 volts may be electrically connected to each respective row line via a plurality of bank switches 218. More specifically, row line 1 is electrically connected to +V_{OLED} via bank switch 218a, row line 2 is electrically connected to +V_{OLED} via bank switch 218b, and row line 3 is electrically connected to +V_{OLED} via bank switch 218c. Bank switches 218 are formed of conventional active switch devices, such as MOSFET switches or transistors having suitable voltage and current ratings.

The matrix of OLEDs 212 within OLED circuit 116 is arranged in the common anode configuration. In this way, the voltage across I_{SOURCES} 214 and the supply voltage, +V_{OLED}, are independent of one another, providing better control of the light emission.

To activate (light up) any given OLED 212, its associated row line is connected to +V_{OLED} via its bank switch 218, and its associated column line is connected to its I_{SOURCE} 214 via its switch 216. However, with reference to FIG. 2, the operation of a specific OLED 212 is as follows. For example, in order to light up OLED 212b, simultaneously, +V_{OLED} is applied to row line 1 by closing bank switch 218a and I_{SOURCE} 214b is connected to column line B by closing switch 216b. At the same time, bank switches 218b and 218c, and switches 216a and 216c are opened. In this way, OLED 212b is forward-biased and current flows through OLED 212b. Once the device threshold voltage of typically 1.5-2 volts is achieved across OLED 212b, OLED 212b emits light. OLED 212b remains lit up as long as bank switch 218a is selecting +V_{OLED} and switch 216b is selecting I_{SOURCE} 214b. To deactivate OLED 212b, switch 216b is opened and the forward-biasing of OLED 212b is removed. Along a given row line, any one or more OLED 212 may be activated at any given time. By contrast, along a given column line, only one OLED 212 may be activated at any given time. In the above-described operation, the states of all switches 216 and bank switches 218 are dynamically controlled by external control circuitry (not shown).

Additionally, a voltage, V_{ISOURCE}, across each I_{SOURCE} 214 may be measured via a plurality of analog-to-digital (A/D) converters 220 as each OLED 212 is activated in a predetermined sequence. More specifically, V_{ISOURCE-A} represents the voltage across I_{SOURCE} 214a and may be measured via A/D converter 220a, V_{ISOURCE-3} represents the voltage across I_{SOURCE} 214b and may be measured via A/D converter 220b, and V_{ISOURCE-C} represents the voltage across I_{SOURCE} 214c and may be measured via A/D converter 220c. A/D converter 220a, A/D converter 220b, and A/D converter 220c convert the analog voltage values of V_{ISOURCE-A}, V_{ISOURCE-B}, and V_{ISOURCE-C}, respectively, to a digital value and subsequently feed this voltage information back to the local or remote processor device via a communications link.

The value of V_{ISOURCE} tends to drop as OLEDs 212 age, i.e., OLEDs 212 become more resistive with age, and the light emission falls accordingly. More specifically, for a set value of +V_{OLED}, as a given OLED 212 becomes more resistive with age, the voltage drop across that OLED 212 increases and, thus, the voltage drop across its associated I_{SOURCE} 214 decreases. Therefore, the value of V_{ISOURCE} at any given time is an indicator of the light output performance of any given OLED 212. Accordingly, voltage compensation to increase +V_{OLED} is performed periodically to compensate for any decrease in V_{ISOURCE} due to the aging of any particular OLED 212.

The measured value of each V_{ISOURCE} may be stored in storage device 118 for interrogation via the local or remote processor device associated with any given module 110 or tile 100. For the example OLED array 210 of FIG. 2, V_{ISOURCE} is measured for each OLED 212 in column A, then B, then C, as follows. V_{ISOURCE-A} is measured for OLED 212a, then OLED 212d, and finally OLED 212g by closing switch 216a and sequencing through bank switch 218a, then bank switch 218b, and finally bank switch 218c, while storing the measured value of V_{ISOURCE-A} for OLEDs 212a, 212d, and 212g in sequence. Likewise, V_{ISOURCE-B} is measured for OLED 212b, then OLED 212e, and finally OLED 212h by closing switch 216b and sequencing through bank switch 218a, then bank switch 218b, and finally bank switch 218c, while storing the measured value of V_{ISOURCE-B} for OLEDs 212b, 212e, and 212h in sequence. Finally, V_{ISOURCE-C} is measured for OLED 212c, then OLED 212f, and finally OLED 212j by closing switch 216c and sequencing through bank switch 218a, then bank switch 218b, and finally bank switch 218c, while storing the measured value of V_{ISOURCE-C} for OLEDs 212c, 212f, and 212j in sequence. Having collected all the V_{ISOURCE} measurements associated with OLED circuit 116, only the worst-case value, i.e., the least positive measurement, needs to be kept in local storage, such as within storage device 118 of its associated module 110.

This worst-case value of V_{ISOURCE} is subsequently compared with an expected minimum value that is typically in the range of 0.4 to 1.0 volts depending on the set-current. If the worst-case value of V_{ISOURCE} is less than this expected minimum value, +V_{OLED} is increased by programming an increase in the output voltage of its associated DC/DC converter 112 by voltage regulator 114. The programmability of DC/DC converter 112 by voltage regulator 114 is accomplished by the local or remote processor device via communications link, as shown in FIG. 1. The voltage increase of DC/DC converter 112 must be sufficient to increase the value of V_{ISOURCE} to within the expected range for that worst case OLED 212. In this way, the proper current flow through all OLEDs 212 to ensure proper and uniform light output across the entire OLED array 210 can be maintained. This minimum value of V_{ISOURCE} is not based upon the threshold of OLEDs 212, but instead is based upon the threshold of I_{SOURCES} 214. This minimum value is set depending upon the specific I_{SOURCE} 214 devices used and the value of the constant current required.

With reference to FIGS. 1 and 2, there is a worst-case V_{ISOURCE} measurement for each module 110; therefore, the voltage output of each DC/DC converter 112 is adjusted accordingly such that V_{ISOURCE} for every OLED circuit 116 within tile 100 is within the accepted range of operation. Since DC/DC converters 112 typically perform only down-conversion, the value of +V_{P/S} of power supply 120 must be set suitably high to accommodate the worst-case V_{ISOURCE} adjustment within tile 100; a typical value of +V_{P/S} is 24 volts. In this way, +V_{OLED} for every OLED circuit 116 within tile 100 is set such that every V_{ISOURCE} value within tile 100 is within the accepted range for ensuring uniform light output. Thus, voltage compensation is accomplished for any decrease in V_{ISOURCE} due to the aging of any particular OLED 212.

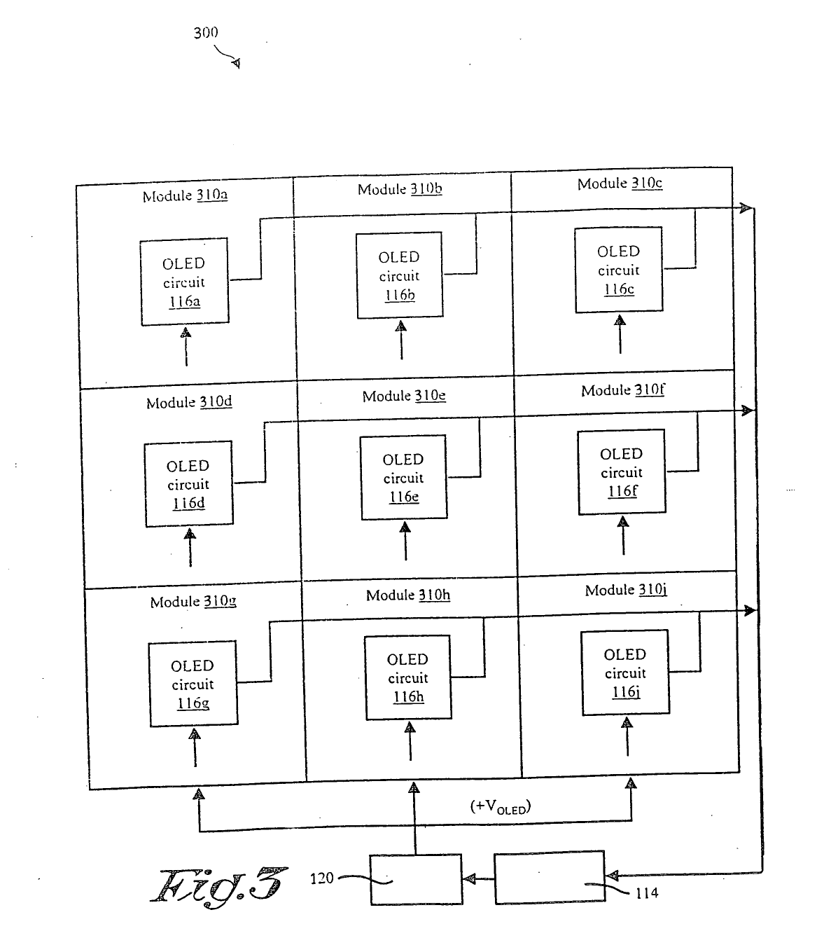

FIG. 3 illustrates an example tile 300, which is representative of a portion of a modular and scalable OLED display system in another embodiment of the invention. Tile 300 is formed of an array of modules 310, for example, but not limited to a module 310a, a module 310b, a module 310c, a module 310d, a module 310e, a module 310f, a module 310g, a module 310h, and a module 310j, arranged in a 3×3 array as shown in FIG. 3. Each module 310 is identical to module 110 of FIG. 1 except that there is no DC/DC converter 112 or voltage regulator 114 present upon each module 310. Instead, each module 310 only includes OLED circuit 116, as described in FIGS. 1 and 2. More specifically, modules 310a through 310j include OLED circuits 116a through 116j, respectively. Furthermore, +V_{OLED} for every OLED circuit 116 is supplied via a direct connection to power supply 120. Furthermore, feedback from OLED circuits 116a through 116j is supplied to voltage regulator 114 that subsequently feeds power supply 120 as shown. As a result, voltage compensation on each individual module 310 via its own DC/DC converter 112 and voltage regulator 114 is not possible. (It is noted that communication to and from modules 310 of tile 300 and power supply 120 is accomplished via the communications link as shown in FIG. 1, but for simplicity is not shown in FIG. 3.)

With reference to FIGS. 2 and 3, voltage V_{ISOURCE} across each I_{SOURCE} 214 is measured via its associated A/D converter 220 while activating each OLED 212; these measurements are stored locally within its associated storage device 118, as described in FIG. 2. Based upon the worst-case V_{ISOURCE} measurement, the +V_{OLED} value of power supply 120 is increased via programming such that the value of the worst-case V_{ISOURCE} is increased to within the predetermined acceptable range. The programmability of power supply 120 is accomplished by the local or remote processor device via communications link. Thus, voltage compensation is accomplished for any decrease in V_{ISOURCE} due to the aging of any particular OLED 212.

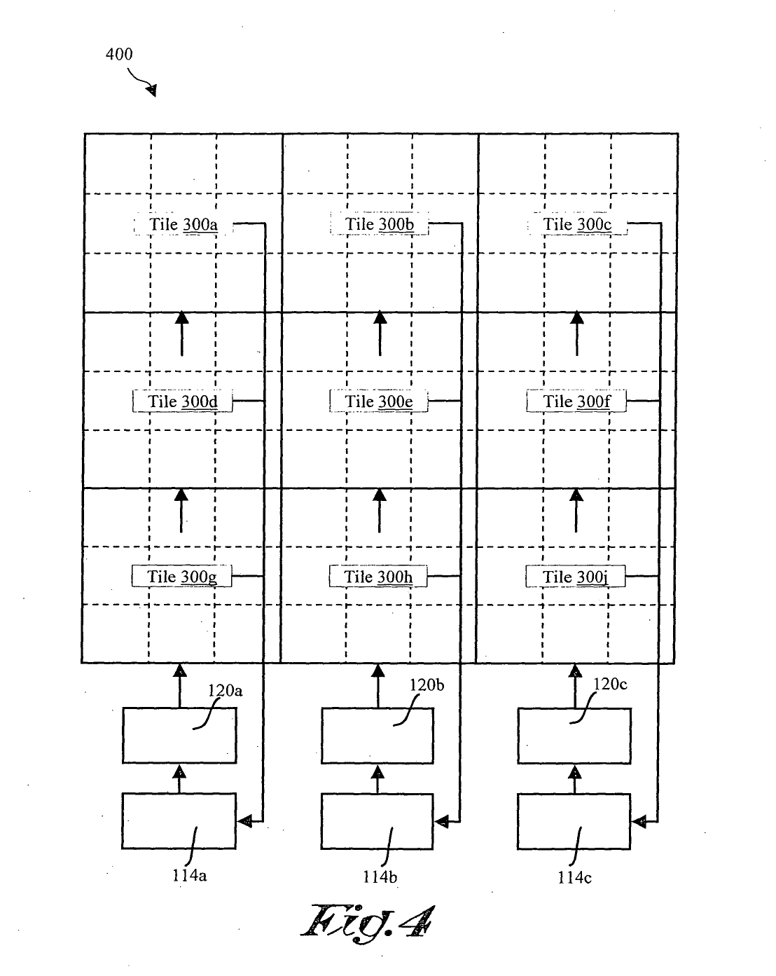

FIG. 4 illustrates an example OLED display 400, which is representative of a modular and scalable OLED display system. OLED display 400 is formed of an array of tiles 300, for example, but not limited to a tile 300a, a tile 300b, a tile 300c, a tile 300d, a tile 300e, a tile 300f, a tile 300g, a tile 300h, and a tile 300j, arranged in a 3×3 array as shown in FIG. 4. Each tile 300 is as described in FIG. 3. Furthermore, OLED display 400 includes a plurality of power supplies 120, each connected to a subset of tiles 300, for example, but not limited to a power supply 120a connected to tiles 300a, 300d, and 300g; a power supply 120b connected to tiles 300b, 300e, and 300h; and a power supply 120c connected to tiles 300c, 300f, and 300j. Furthermore, feedback from tiles 300a, 300d, and 300g is supplied to a voltage regulator 114a that subsequently feeds power supply 120a; feedback from tiles 300b, 300e, and 300h is supplied to a voltage regulator 114b that subsequently feeds power supply 120b; feedback from tiles 300c, 300f, and 300j is supplied to a voltage regulator 114c that subsequently feeds power supply 120c; as shown. As a result, voltage compensation is accomplished for a subset of tiles 300 rather than for each individual tile 300, as described in FIG. 3. It is noted that communication to and from tiles 300 of OLED display 400, power supplies 120, and voltage regulators 114 is accomplished via the communications link as shown in FIG. 1, but for simplicity is not shown in FIG. 4.

Again, based upon the worst-case V_{ISOURCE} measurement within an entire subset of tiles 300, the +V_{OLED} value of a particular power supply 120 is increased via programming such that the value of the worst-case V_{ISOURCE} is increased to within the predetermined acceptable range. The programmability of each power supply 120 and each voltage regulator 114 is accomplished by the local or remote processor device via communications link. More specifically, power supply 120a is adjusted based upon the worst-case V_{ISOURCE} measurement within tiles 300a, 300d, and 300g; power supply 120b is adjusted based upon the worst-case V_{ISOURCE} measurement within tiles 300b, 300e, and 300h; and power supply 120c is adjusted based upon the worst-case V_{ISOURCE} measurement within tiles 300c, 300f, and 300j. Thus, voltage compensation is accomplished for any decrease in V_{ISOURCE} due to the aging of any particular OLED 212 within OLED display 400.

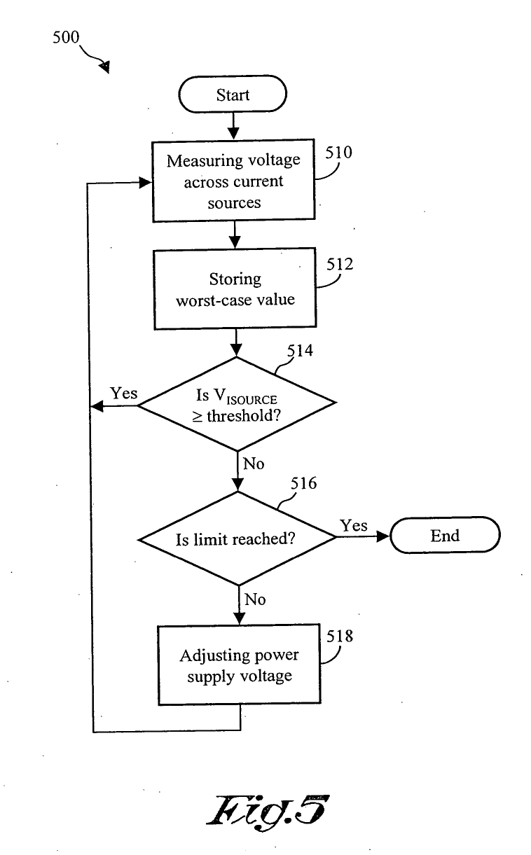

FIG. 5 is a flow diagram of a method 500 of providing voltage compensation within an OLED display device in accordance with the invention. Method 500 of providing voltage compensation within an OLED display device is performed at regular time intervals, such as hourly, daily, or weekly. Method 500 assumes the presence of a local or remote processor device that is loaded with the appropriate software routines. FIGS. 1 through 4 are referenced throughout the steps of method 500. Method 500 includes the following steps:
Step 510: Measuring voltage across current sources

In this step, the voltage V_{ISOURCE} across each I_{SOURCE} 214 within each OLED circuit 116 of, for example, each module 110 of tile 100 or each module 310 of tile 300, is measured via its associated A/D converters 220 as each OLED 212 is activated in a predetermined sequence. With reference to OLED array 210 of FIG. 2, for example, V_{ISOURCE} is measured for each OLED 212 in column A, then column B, and then column C, as follows. V_{ISOURCE-A} is measured for OLED 212a, then OLED 212d, and finally OLED 212g by closing switch 216a and sequencing through bank switch 218a, then bank switch 218b, and finally bank switch 218c. Likewise, V_{ISOURCE-B} is measured for OLED 212b, then OLED 212e, and finally OLED 212h by closing switch 216b and sequencing through bank switch 218a, then bank switch 218b, and finally bank switch 218c. Finally, V_{ISOURCE-C} is measured for OLED 212c, then OLED 212f, and finally OLED 212j by closing switch 216c and sequencing through bank switch 218a, then bank switch 218b, and finally bank switch 218c. Method 500 proceeds to step 512.
Step 512: Storing worst-case value

In this step, the local or remote processor device receives the digital output of all A/D converters 220 within a given OLED circuit 116 via the communications link and stores the worst-case V_{ISOURCE} value, i.e., the least positive V_{ISOURCE} measurement, for each module 110 or module 310 in local storage, such as within storage device 118 of each module 110 or module 310. Method 500 proceeds to step 514.
Step 514: Is V_{ISOURCE}≧threshold?

In this decision step, the local or remote processor device determines whether the worst-case V_{ISOURCE} value for each module 110 or module 310 is greater than or equal to a predetermined minimum threshold voltage associated with I_{SOURCES} 214. A typical minimum threshold voltage is, for example, 0.7 volts. This is determined by comparing the stored worst-case V_{ISOURCE} values to this predetermined minimum threshold voltage. This compare operation is performed by any standard local or remote processor device via standard communications links. If yes, method 500 returns to step 510 where another measurement is preformed. If no, method 500 proceeds to step 516.
Step 516: Is limit reached?

In this decision step, the local or remote processor device determines whether the maximum power dissipation=maximum setpoint-voltage, as set at design time, for any given module 110 of tile 100 or any given module 310 of tile 300 has reached a predetermined level. If yes, method 500 ends. If no, method 500 proceeds to step 518.
Step 518: Adjusting power supply voltage

In this step, +V_{OLED} for every OLED circuit 116 is adjusted such that every V_{ISOURCE} value within a given OLED circuit 116 is more positive than the minimum threshold voltage referred to in step 514. In the case of tile 100 of FIG. 1, the voltage output of each DC/DC converter 112 is adjusted accordingly such that V_{ISOURCE} for every OLED circuit 116 within tile 100 is within the accepted range of operation. In the case of tile 300 of FIG. 3, the voltage output of power supply 120 is adjusted accordingly such that V_{ISOURCE} for every OLED circuit 116 within tile 300 is within the accepted range of operation. In the case of OLED display 400 of FIG. 4, the voltage output of power supplies 120a, 120b, and 120c are adjusted accordingly such that V_{ISOURCE} for every OLED circuit 116 within the subsets of tiles 300 is within the accepted range of operation. The task of adjusting either DC/DC converters 112 and voltage regulators 114 or power supplies 120 is performed by the local or remote processor device via the communications link. Method 500 returns to step 510.

Summarized, method 500 of the present invention measures the voltage drop across a set of constant current sources, for example, I_{SOURCES} 214, within the drive circuit of a common-anode, passive-matrix, large-screen OLED array, for example, OLED circuits 116 of tile 100, as an indicator of OLED light output. Subsequently, a positive power supply, for example, power supply 120, associated with the large-screen OLED array is adjusted to ensure that the voltage at the cathode of each OLED, such as each OLED 212, is greater than or equal to a predetermined threshold voltage. Accordingly, voltage compensation is performed periodically to compensate for any decrease in light emission due to the aging of OLEDs 212. Furthermore, method 500 of the present invention ensures that a predetermined maximum power dissipation is not exceeded.

Although, the examples shown in the figures provide a control for each module individually, it is clear that, according to an alternative, the control of the invention can also be realized in other manners. For example, the power supply can be adjusted for each tile individually, and not for each module. Also in case of a non-tiled display, separate controls and adjustments can be carried out for groups of OLEDs. Even in a display composed of tiles and/or modules, the groups of OLEDs for which the power supply is controlled per group, must not necessarily correspond with the OLEDs belonging to a tile or a module.

It is clear that the construction of the electronic circuit which is required to realize the display of the invention, and in particular the control and drive devices thereof, starting from the description given before, can be realized by any person skilled in the art.

The present invention is in no way limited to the forms of embodiment described by way of example and represented in the figures, however, such method for controlling an organic light-emitting diode display, as well as such organic light-emitting diode display, can be realized in various forms without leaving the scope of the invention.

1. Method for controlling an organic light-emitting diode display, said display comprising a plurality of organic light-emitting diodes (OLEOS) having an anode and a cathode, said organic light emitting diodes being arranged in a common anode configuration, whereby said diodes co-operate with constant current sources and are fed by means of a power supply, characterized in that a power voltage supply compensation is applied, in which a drop is measured across the current sources and wherein the measured voltage drop is used as an indicator for the light output of the organic light emitting diodes and wherein said power supply is adjusted in function of said measured voltage drop.

2. Method according to claim 1, characterized in that said power supply is adjusted such that the voltage at the cathode of each organic light emitting diode is greater than or equal to a predetermined threshold voltage.

3. Method according to claim 1 or 2, characterized in that this method, in particular said power compensation, is performed periodically.

4. Method according to claim 1, characterized in that in order to measure the voltage drop, the organic light-emitting diodes are activated in a predetermined sequence.

5. Method according to claim 1, characterized in that the voltage drop is measured via analog-to-digital converters.

6. Method according to claim 1, characterized in that at least a number of the measured values of voltage or voltage drop are stored in a storage device for interrogation.

7. Method according claim 1, characterized in that one or more of the current sources each co-operate with a plurality of said organic light-emitting diodes, whereby the voltage drop across such current source is measured for each of the diodes coupled to the corresponding current source by sequentially actuating these diodes.

8. Method according to claim 1, characterized in that the organic light-emitting diodes of the display are divided in groups, each group having its own power supply regulation, whereby the abovesaid measurement is carried out per group and the worst case value of the measurement is used for controlling the power supply of said group.

9. Method according to claim 8, characterized in that it is used in a large-screen application, said screen being composed of a plurality of display tiles, whereby said control is applied at least individually for each of the tiles.

10. Method according to claim 9, characterized in that each of said tiles is composed of a plurality of modules and in that said control is applied individually for each of the modules.

11. Method according to claim 10, characterized in that a limit control is applied, whereby, when a preset value of maximum power of the display or for a module dissipation is obtained for a portion in particular for a tile, said method of controlling is interrupted.

12. Organic light-emitting diode display, characterized in that it comprises electronics allowing to carry out the method of any of claims 1 to 11.
